(19) United States
(12) Patent Application Publication
(10) Pub. No.: US 2016/0350680 A1
(43) Pub. Date: Dec. 1, 2016

(54) TICKET VALUE IDENTIFICATION IN AN ELECTRONIC MARKETPLACE

(71) Applicant: eBay Inc., San Jose, CA (US)

(72) Inventors: Kane Sweeney, San Jose, CA (US); Clifford Lyon, San Jose, CA (US); Xiao Fan Xu, San Jose, CA (US)

(21) Appl. No.: 15/167,875

(22) Filed: May 27, 2016

Related U.S. Application Data
(60) Provisional application No. 62/168,179, filed on May 29, 2015.

(51) Int. Cl. G06Q 10/02; G06Q 30/06; G06Q 30/02

(52) U.S. Cl. CPC G06Q 10/02; G06Q 30/0283; G06Q 30/0643

(57) ABSTRACT

A method of ticket assessment includes accessing historical transaction information and prices for available tickets for an upcoming event. The method includes calculating a historical ticket value for seats at a venue and a current ticket value and a deal score for the available tickets. The method includes receiving a preference that pertains to a ticket for the upcoming event. The method includes determining whether the available tickets include characteristics within the preference. If a first subset of the available tickets includes characteristics within the preference, the method includes communicating to the user device recommendation data including ticket listings for tickets in the first subset. The recommendation data is configurable in a window of a graphical user interface. If a second subset of the available tickets does not include characteristics within the preference, the method includes filtering the second subset of the available tickets from the recommendation data.

### RELATED APPLICATIONS

This application claims the benefit of and priority to U.S. Provisional Application No. 62/168,179 filed May 29, 2015, which is incorporated herein by reference in its entirety.

### FIELD

Embodiments described in this disclosure generally relate to ticket value identification in an electronic marketplace.

### BACKGROUND

Some online web services enable exchange of tickets for events. The tickets may be used to reserve seats and/or admission for the events, which may include sporting events, concerts, theater events, parking at such events, and other events. Using the online web services, a user may search for available tickets and decide which, if any, of available tickets are of interest based on information provided by the online service.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of ticket assessment in an online ticket marketplace. The method may include accessing, by a marketplace server, historical transaction information that pertains to previous transactions for events at a venue from a transaction database and accessing prices for one or more available tickets for an upcoming event at the venue. The method may include calculating, by the marketplace server, a historical ticket value for seats at the venue. The historical ticket value may be based on a price at which a particular seat sold relative to asking/listing prices for tickets for other seats that were available at the time the particular seat was purchased. The historical ticket value may also be based on a number of times the particular seat was purchased while the other seats were available. The method may include calculating, by the marketplace server, a current ticket value for each of the one or more available tickets based on an average price difference between the price of the available ticket and prices of other available tickets. The method may include calculating, by the marketplace server, a deal score for each of the one or more available tickets. The deal scores may be indicative of whether the available ticket is overpriced or underpriced. The method may include receiving, from a user device associated with a buyer entity, user input that includes a preference that pertains to a ticket for the upcoming event. The method may include determining, by the marketplace server, whether each of the one or more available tickets include characteristics that are within the preference. In response to a determination that a first subset of the one or more available tickets includes characteristics that are within the preference, the method may include communicating to the user device recommendation data that includes ticket listings for each of the one or more available tickets in the first subset. The recommendation data may be configurable in a window of a graphical user interface (GUI) such that the ticket listings are positioned relative to one another ranked according to the deal score of the available ticket. In response to a determination that a second subset of the one or more available tickets does not include characteristics that are within the preference, the method may include filtering, by the marketplace server, the second subset of the one or more available tickets from the recommendation data.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE FIGURES

FIG. 1 illustrates an example operating environment in which an online ticket marketplace may be implemented;

FIG. 2 illustrates an example ticket transaction process that may be implemented in the operating environment of FIG. 1;

FIG. 3 is an example graphical user interface (GUI) that may be implemented in the operating environment of FIG. 1;

FIG. 4 is an example window that includes one or more actuatable elements that may be implemented in the operating environment of FIG. 1;

FIG. 5 illustrates an example computing system configured for ticket value assessment based on user preferences;

FIGS. 6A and 6B depict a flow chart of an example method of ticket assessment in an online ticket marketplace; and

FIGS. 7A-7C depict a flow chart of another example method of ticket assessment in an online ticket marketplace.

### DETAILED DESCRIPTION OF SOME EXAMPLE EMBODIMENTS

Online ticket marketplaces provide a convenient forum via which users (e.g., buyers and sellers) may exchange tickets. However, the online ticket marketplaces enable tickets to be exchanged and re-exchanged at prices specified by a seller. A buyer may have insufficient information with which to evaluate whether to purchase tickets at a listed price and/or which of a set of available tickets, which may seem similar, to purchase. In addition, many factors may contribute to the value of a seat for a particular event. For example, popular teams may be participating or a popular player may be retiring, which may drive prices up for seats. Consequently, sellers may have insufficient information from which the listed price can be set.

Accordingly, in embodiments described in this disclosure, a marketplace server that hosts an online ticket marketplace may use historical transaction information along with prices for available tickets to generate evaluation criteria with which sellers can determine a fair asking price and with which buyers can evaluate potential transactions.

In some embodiments, the buyer may input one or more preferences, which a marketplace server may use to filter available tickets. For instance, the buyer may be interested in the best quality ticket at any price. Accordingly, the marketplace server may generate a set of available seats for the buyer based solely on quality. Contrarily, the buyer may be price sensitive and not concerned with quality. Accordingly, the marketplace server may generate a set of available seats based solely on price. More commonly, the buyer is interested to some extent in both price and quality. Accordingly, the marketplace server may be configured to receive as input an indication of the buyer's sensitivity to price and to quality. Based on such input, the marketplace server may provide to the buyer a ranked set of available tickets. The buyer may then view the set, which may be ranked based on quality and based on price. Moreover, the marketplace server can filter, organize, and communicate available tickets and information associated therewith to the buyers based on the evaluation criteria and/or preferences input by the users. Thus, the buyer can make a meaningful evaluation of the available tickets, which again takes into consideration preferences of the buyer.

These and other embodiments are described with reference to the appended drawings in which like numbers indicate like features and structures unless described otherwise.

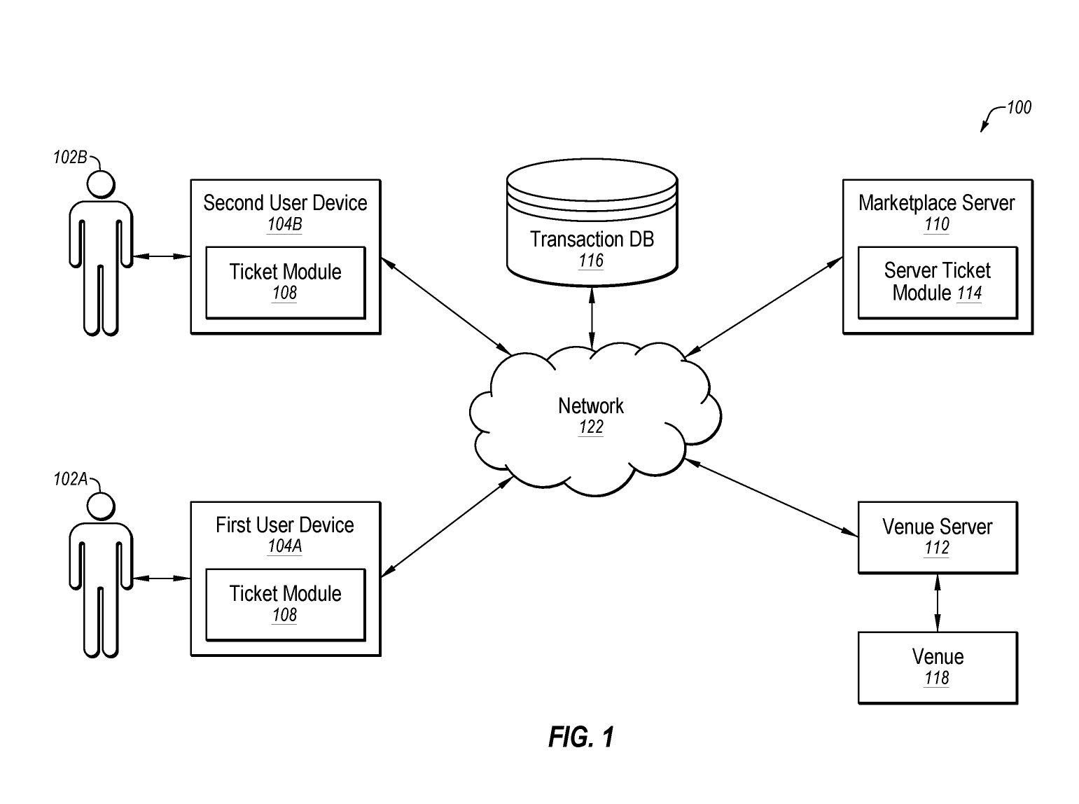

FIG. 1 illustrates an example operating environment 100 in which an online ticket marketplace (hereinafter, “marketplace”) may be implemented. In the operating environment 100, users 102A and 102B (generally, user 102 or users 102) may interact with user devices 104A and 104B (generally, user device 104 or user devices 104) to search for and/or obtain tickets, which may be listed on a site that is hosted and/or controlled by a marketplace server 110. The tickets may be for an event that occurs at a venue 118. As the user 102 interacts with the marketplace server 110 via the user device 104, recommendation data may be provided to the user device 104 from the marketplace server 110 via a network 122.

The ticket recommendation data may be based at least partially on user input. The user input may be received at the user device 104 and may be communicated to the marketplace server 110. The user input may include preferences related to a ticket purchase at the venue 118. For instance, the preferences may include a preference as to a price, a price range preference, a seat quality preference, a seating section preference, a preferred characteristic of the ticket (e.g., a general admission, a bench seat, or a lawn seat), some combination thereof, or some other preference related to seating and/or tickets. The marketplace server 110 may be configured to filter which tickets are recommended to the user 102 based on the preferences. For example, tickets that may be available for an upcoming event, but do not meet one or more of the preferences may be filtered from the ticket recommendation data.

In addition, the marketplace server 110 may be configured to generate one or more evaluation criteria. In general, the evaluation criteria include quantitative metrics of a ticket and/or a location reserved by the ticket (e.g., a seat). The quantitative metrics may rate the ticket or the location with respect to the venue 118, with respect to one or more other tickets, with respect to one or more other seats, or some combination thereof. The evaluation criteria may be based on historical transaction information, which may be stored in a transaction database 116 (in FIG. 1 transaction DB 116). The evaluation criteria may additionally be based on information that pertains to the venue 118, information that pertains to an upcoming event, information regarding currently available tickets, or some combination thereof. In some embodiments, the evaluation criteria may include a quality score, a historical ticket value, a current ticket value, and a deal score. Some details of the quality score, the historical ticket value, the current ticket value, and the deal score are provided elsewhere in this disclosure. The evaluation criteria or some representation thereof may be included in recommendation data, which may be presented to the users 102 at the user devices 104.

The operating environment 100 of FIG. 1 may include the marketplace server 110, the user devices 104, the network 122, the transaction database 116, and a venue server 112 that is associated with the venue 118. The marketplace server 110, the transaction database 116, the user devices 104, and the venue server 112 (collectively, environment components) may communicate information and data via the network 122. For example, one or more of the environment components may communicate information and data related to recommendation data, preferences, ticket listings, and price recommendations. Each of the environment components is briefly described in the following paragraphs.

The network 122 may include a wired network, a wireless network, or any combination thereof. The network 122 may include any suitable configuration or configurations including a star configuration, token ring configuration, or other configurations. The network 122 may include a local area network (LAN), a wide area network (WAN) (e.g., the Internet), and/or other interconnected data paths across which multiple devices may communicate. In some embodiments, the network 122 may include a peer-to-peer network. The network 122 may also be coupled to or include portions of a telecommunications network that may enable communication of data in a variety of different communication protocols. In some embodiments, the network 122 includes BLUETOOTH® communication networks and/or cellular communication networks for sending and receiving data including via short messaging service (SMS), multimedia messaging service (MMS), hypertext transfer protocol (HTTP), direct data connection, wireless application protocol (WAP), e-mail, and the like.

The user 102 may include an individual or an entity that may interface with the user device 104 to participate in a ticket transaction. Participation in the ticket transaction may include, for example, an offer or listing of a ticket for sale; searching for a ticket to an upcoming event, which may include input of one or more preferences; purchase of a ticket; requesting a suggested price for a ticket; or some combination thereof. For example, the user 102 may include an individual who wants to purchase a ticket for an upcoming event that is scheduled to take place at the venue 118. The user 102 may also include an individual who wants to sell a ticket for the upcoming event.

In some embodiments, the users 102 may act as a seller entity and as a buyer entity. For instance, in a first transaction, a first user 102A may purchase a ticket from a second user 102B and in a second transaction; the first user 102A may sell a ticket to the second user 102B.

The user devices 104 may include a computing device that may include a processor, memory, and network communication capabilities. The user devices 104 may be configured for communication with one or more other environment components via the network 122. Some examples of the user devices 104 include a laptop computer, a desktop computer, a tablet computer, a smartphone, a personal digital assistant (“PDA”), a mobile e-mail device, a portable game player, smart wearable technology, or any other applicable electronic device capable of accessing the network 122.

The user devices 104 may include a ticket module 108. The ticket module 108 may be configured to implement a marketplace interaction with the marketplace server 110. For example, the ticket module 108 may enable input and communication of ticket listings and/or preferences from the user devices 104 to the marketplace server 110. In addition, the ticket module 108 may enable reception of recommendation data and/or a price suggestion from the marketplace server 110 and display of recommendation data and/or a price suggestion at the user devices 104.

The ticket module 108 may be implemented using hardware including a processor, a microprocessor (e.g., to perform or control performance of one or more operations), a field-programmable gate array (FPGA), or an application-specific integrated circuit (ASIC). In some other instances, the ticket module 108 may be implemented using a combination of hardware and software. Implementation in software may include rapid activation and deactivation of one or more transistors or transistor elements such as may be included in hardware of a computing system (e.g., the user device 104). Additionally, software defined instructions may operate on information within transistor elements. Implementation of software instructions may at least temporarily reconfigure electronic pathways and transform computing hardware.

The venue 118 may include any forum in which events take place or are performed. Some examples of the venue 118 may include a stadium, an arena, a theatre, a parking lot, a fairground, and the like. The event may include any type of happening in which tickets are used for entry. Some examples of the event are sporting events, concerts, plays, movies, festivals, parking for other events, and the like. The venue 118 may be associated with the venue server 112.

The venue server 112 may include a hardware server that includes a processor, memory, and network communication capabilities. In the illustrated implementation, the venue server 112 is configured to communicate via the network 122 with the other environment components. The venue server 112 may track and generate event information that pertains to one or more events at the venue 118. For example, the event information may include prices of available tickets for an upcoming event, distances between locations reserved by tickets relative to a point of interest during specific events, prices at which tickets were sold for previous events, ticket availability for events, and event schedule information (e.g., time, date, participants, and the like). The event information may be communicated to the marketplace server 110 and/or the transaction database 116. In addition, one or more portions of the event information may be updated as tickets are sold or circumstances change for an event. Updated ticket information may be communicated to the transaction database 116 and/or the marketplace server 110.

The transaction database 116 may include any storage device or storage devices capable of data storage in the operating environment 100. The transaction database 116 may store and maintain historical transaction information. The historical transaction information may include data and information related to previous ticket transactions performed in the operating environment 100 and/or at the venue 118.

The transaction database 116 may be accessible to marketplace server 110 and/or the venue server 112. For instance, the venue server 112 may store event information in the transaction database 116. Additionally, the marketplace server 110 may access the historical transaction information from the transaction database 116 and/or store the historical transaction information at the transaction database 116. Although not explicitly shown in FIG. 1, the event information and/or the historical transaction information in the transaction database 116 may also originate at other sources. In the embodiment of FIG. 1, the transaction database 116 is depicted separate from the marketplace server 110. In other embodiments, the transaction database 116 may be included, at least partially, in the marketplace server 110.

The marketplace server 110 may include a hardware server that includes a processor, memory, and network communication capabilities. In the illustrated implementation, the marketplace server 110 is configured to communicate via the network 122 with the other environment components.

The marketplace server 110 may include a server ticket module 114. The server ticket module 114 may be configured to implement a marketplace interaction with the user device 104. The marketplace interaction may include generation of one or more evaluation criteria related to a ticket or a location reserved by the ticket. Additionally, the marketplace interaction may include reception of the one or more preferences from one of the user devices 104 and performance of a filtering operation based on the received preferences.

For example, in some embodiments, the server ticket module 114 may access historical transaction information. The historical transaction information may pertain to previous ticket transactions for events at the venue 118 and may be accessed from the transaction database 116. The server ticket module 114 may also access event information that pertains to the venue 118.

The server ticket module 114 may also receive from one or both of the user devices 104 one or more ticket listings. The ticket listings may be for one or more particular locations (e.g., seats) and may include prices for an upcoming event. The server ticket module 114 may also receive from one or both of the user devices 104 user input that may include preferences such as an indication of a seat quality preference and a price preference for the upcoming event.

The server ticket module 114 may calculate one or more evaluation criteria based on the historical transaction information, the event information, the ticket listings, or some combination thereof. In some embodiments, the evaluation criteria may include a quality score, a historical ticket value, a current ticket value, and a deal score. Each of these evaluation criteria is introduced in the following paragraphs using a seat as an example location that is reserved by a ticket. It may be appreciated with the benefit of this disclosure that although some features are described with respect to a seat, those features may be applicable to circumstances in which a ticket reserves another location such as a parking spot, a general admission area, entry into a venue, participation in an event, and the like.

The quality score may apply to the seat that is reserved by a ticket. The quality score may be indicative of an experience of the user 102 when positioned (e.g., seated) in the seat that is reserved by the ticket. For example, the quality score may be based on a distance from a point of interest of the venue 118 to a seat that is reserved by the ticket. Additionally or alternatively, the quality score may be generated based on one or more other factors, some details of which are described elsewhere herein.

Ticket value is generally the quality of the seat that a buyer receives per unit price. For instance better quality seats usually have higher prices and lower quality seats usually have lower prices. The ticket value normalizes relationships between the quality of the seats and the prices. In addition, the ticket value for a seat is relative to other seats in the venue 118. Ticket value is described in this disclosure as two quantities the historical ticket value and the current ticket value. The historical ticket value provides the historical context from which the current ticket value can be assessed. The assessment of current ticket values relative to the historical ticket values is included in the calculation of the deal score.

The historical ticket value may apply to the seat relative to all other seats in the venue 118. The historical ticket value may be based on historical transaction information. The historical ticket value may be indicative of historical prices paid for tickets relative to historical prices paid for tickets for one or more of the other seats of the venue 118.

The current ticket value may apply to a ticket that is currently available for an upcoming event and the seat that is reserved by the ticket. The current ticket value may be based on a price of the ticket relative to other available tickets.

The deal score may also apply to the ticket that is currently available for an upcoming event and the seat that is reserved by the ticket. The deal score may be based on the current ticket value and the historical ticket value. The deal score may be indicative of whether the ticket is overpriced or underpriced considering the current ticket value and the historical ticket value.

The server ticket module 114 may be configured to filter one or more available tickets based on the preference and/or one or more of the evaluation criteria and communicate recommendation data configured according to the filtering operations. For example, the server ticket module 114 may determine whether one or more seats include characteristics that fall within the seat quality preference and the price preference. In response to the one or more seats including characteristics that fall within the preferences, ticket listings for tickets that reserve the seats may be included in the recommendation data.

Additionally or alternatively, the server ticket module 114 may rank calculated deal scores. For instance, the server ticket module 114 may determine whether a first deal score for a first location is greater than a second deal score for a second location. The server ticket module 114 may communicate the recommendation data to one or both of the user devices 104. The recommendation data may be configurable in a display window in accordance with the rank of the calculated deal scores. For instance, the recommendation data may be configurable such that a first ticket listing is positioned relative to a second ticket listing to indicate that the first deal score is greater than the second deal score.

The server ticket module 114 may be implemented using hardware including a processor, a microprocessor (e.g., to perform or control performance of one or more operations), an FPGA, or an ASIC. In some other instances, the server ticket module 114 may be implemented using a combination of hardware and software. Implementation in software may include rapid activation and deactivation of one or more transistors or transistor elements such as may be included in hardware of a computing system (e.g., the marketplace server 110). Additionally, software defined instructions may operate on information within transistor elements. Implementation of software instructions may at least temporarily reconfigure electronic pathways and transform computing hardware.

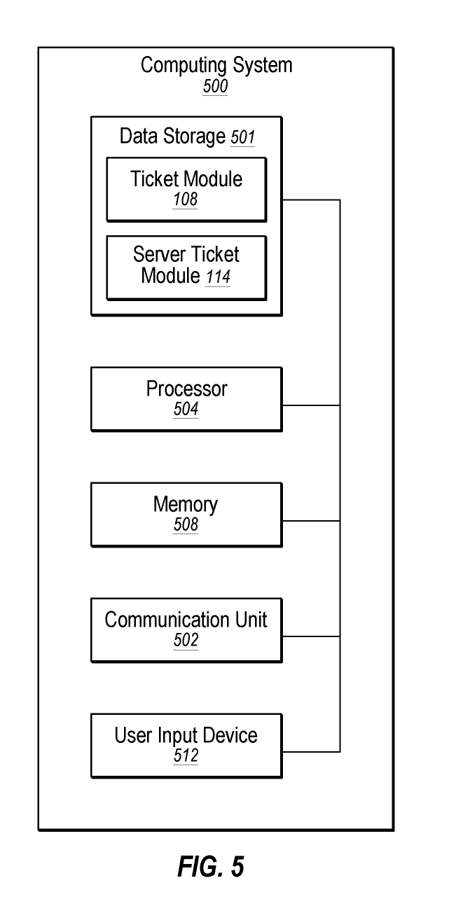

In the operating environment 100, memory in one or more of the environment components may be similar to memory 508 described with reference to FIG. 5, processors in one or more of the environment components may be similar to a processor 504 described with reference to FIG. 5, and network communication capabilities of one or more of the environment components may be provided by a communication unit 502 described with reference to FIG. 5.

Modifications, additions, or omissions may be made to the operating environment 100 without departing from the scope of the present disclosure. Specifically, embodiments depicted in FIG. 1 include one or more user devices 104, one or more users 102, one or more venue servers 112, one or more venues 118, one or more marketplace servers 110, or some combination thereof.

Moreover, the separation of various components in the embodiments described herein is not meant to indicate that the separation occurs in all embodiments. It may be understood with the benefit of this disclosure that the described components may be integrated together in a single component or separated into multiple components. For example, in some embodiments the transaction database 116 may be included in the marketplace server 110.

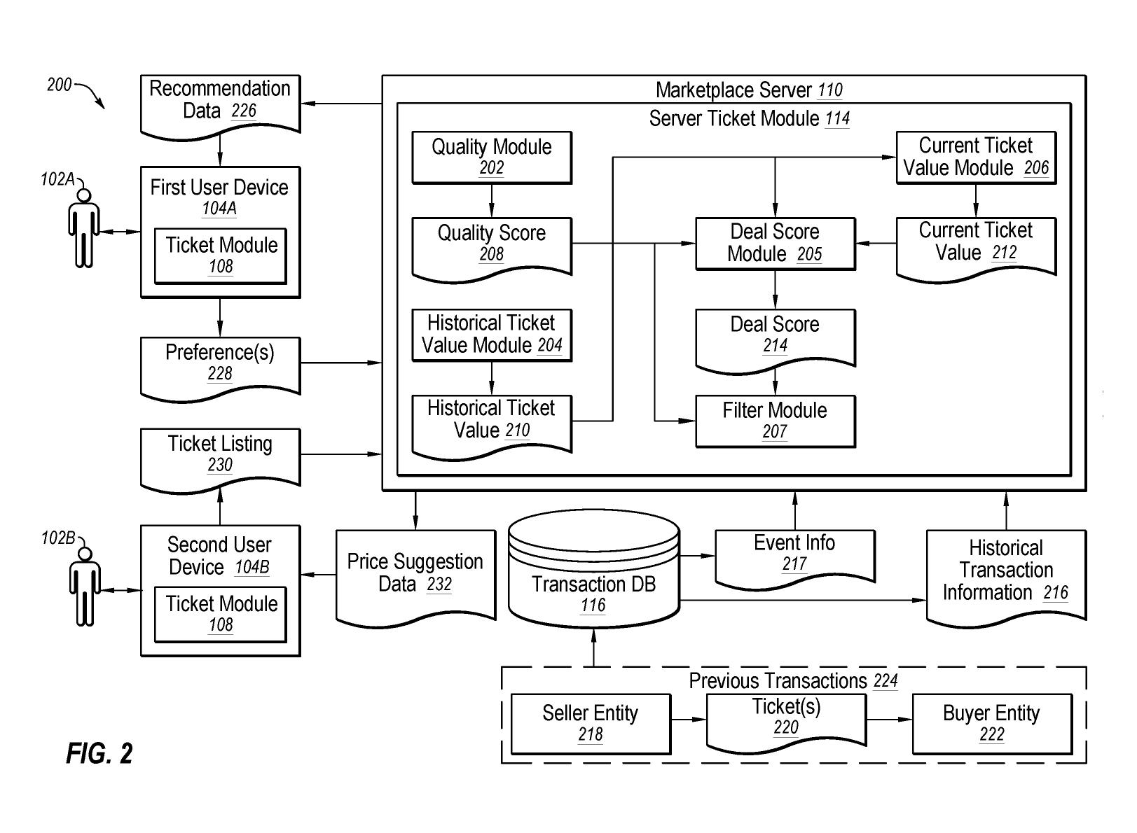

FIG. 2 illustrates an example ticket transaction process 200 that may be implemented in the operating environment 100 of FIG. 1. In the process 200 of FIG. 2, the users 102, the user devices 104, the marketplace server 110, and the transaction database 116 described with reference to FIG. 1 are involved. Although not depicted in the process 200 of FIG. 2, communication of information and data may be performed via a network such as the network 122 of FIG. 1.

The process 200 of FIG. 2 may begin with previous transactions 224. In the previous transactions 224, a seller entity 218 may exchange one or more tickets 220 with a buyer entity 222 for an event at a venue (e.g., the venue 118). The seller entity 218 and the buyer entity 222 may be a user such as one of the users 102. The previous transactions 224 may produce and/or result in historical transaction information 216 and/or event information 217 (in FIG. 2, “event info 217”). The historical transaction information 216 and/or event information 217 may include a price exchanged for the tickets 220, other tickets on sale when the tickets 220 were exchanged and prices for the other tickets 220, information about the venue in which the event occurred, other transaction information, or some combination thereof.

The historical transaction information 216 and/or event information 217 may be stored in the transaction database 116. The historical transaction information 216 and/or event information 217 may be communicated to or accessed by the marketplace server 110.

In addition, in the process 200 of FIG. 2, the server ticket module 114 may receive a ticket listing 230 and user input. The ticket listings 230 and the user input may be received from the user devices 104. In the depicted embodiment, the user input may include preferences 228. The preferences 228 may include a price preference and/or a quality preference. Additionally, the preferences 228 may include a selection of a seating section in the venue. For example, the second user device 104B may be associated with the second user 102A who is a seller entity. The second user device 104B may communicate the ticket listing 230 to the marketplace server 110. The ticket listing 230 may be for a particular seat and may include a particular price for a particular ticket that reserves the particular seat during an upcoming event.

Additionally, the first user device 104A associated with the first user 102A who is a buyer entity. The first user device 104A may communicate user input that includes the preferences 228. In addition, the user input may include a selection of a seating section in the venue.

As described above, the server ticket module 114 may be configured to generate recommendation data 226 and/or price suggestion data 232. The recommendation data 226 and/or price suggestion data 232 may be based on one or more evaluation criteria, which may be further based on the ticket listing 230, the preferences 228, the event information 217, the historical transaction information 216, or some combination thereof. The server ticket module 114 of FIG. 2 may be configured to generate evaluation criteria that may include a quality score 208, a historical ticket value 210, a data score 214, a ticket value 212, or some combination thereof. Accordingly, the server ticket module 114 may include a quality module 202, a historical value module 204, a ticket value module 206, a deal score module 205, and a filter module 207.

The quality module 202 may be configured to calculate the quality score 208 for one or more locations in the venue. For example, the quality module 202 may be configured to calculate the quality score 208 for one or more or all of the seats in the venue with the venue in one or more particular configurations. In other example embodiments, the quality module 202 may be configured to calculate the quality score 208 for one or more parking spaces, one or more portions of a general admission section of the venue, and one or more sections of a standing area of the venue.

The quality score 208 may be indicative of an experience of a user (e.g., one or both of the users 102) positioned in the location during events. For example, a higher quality score calculated for a first location may indicate that the user may be able to see, hear, or otherwise be exposed to a point of interest of the venue better than a second location with a relatively lower quality score.

The quality score 208 for a location may be calculated based on the historical transaction information 216, the event information 217, predetermined quality metrics, or some combination thereof. In some embodiments, the quality module 202 may calculate the quality score 208 based on the average purchase price of tickets for each location. Generally, higher quality seats will have higher average purchase prices. Similarly, the quality score 208 of the seats may be determined based on the average asking/listing price.

Additionally or alternatively, the quality score 208 for a location may be based on distance information, such as a distance from the venue and/or a point of interest of the venue (e.g. distance from home plate, first plate, foul post, fifty yard line, center court, goal, concert stage, theatre stage, and/or the like).

In some examples, geolocators may be used to determine the distance. For example, user devices (e.g., the user devices 104) from attendees who have confirmed purchases or electronic ticket purchases may provide geolocations for a location such as a seat. The server ticket module 114 may then determine the distance of the location from the provided geolocation and another geolocation for the venue, such as home plate. Other considerations may include, angle of view from the seat, distance to concession stands, exclusive access to certain areas of the venue, whether the seats are in a VIP room or a club room, and/or the like.

In some embodiments, the quality score 208 may have predetermined quality scores 208 for all of the seats in a venue pre-set by an operator of marketplace server 110. The quality scores 208 may rank the quality of each seat.

The server ticket module 114 may be configured to calculate a historical ticket value 210 and/or a current ticket value 212 for one or more locations in the venue. Both the historical ticket value 210 and the current ticket value 212 may provide information of the value of a location in the venue relative to some or all other locations in the venue. The value is generally an indication of the quality of a location relative to its price.

The historical value module 204 is configured to calculate the historical ticket value 210. The historical ticket value 210 may include a value (e.g., quality per price) assessment of a seat based primarily on the previous transactions 224 for the seat.

In some embodiments, the historical ticket value 210 may be calculated to represent an upgrade value from a less-expensive available location. For example, the historical ticket value 210 may be calculated for a particular seat by relating a ticket purchased for the particular seat to other tickets that were less-expensive and concurrently for sale. The historical ticket value 210 may accordingly provide information regarding a price for the particular seat versus a purchase of a worse seat (e.g., a downgrade).

In these and other embodiments, the historical value module 204 may calculate the historical ticket value 210 for a seat according to a downgrade value expression:

$${MDV}_{i} = \sum \frac{Purchased seat price - cheaper seat price}{Number of instances} .$$

In the downgrade value expression, the parameter i represents an indexing variable for the seat in the venue. The parameter MDVᵢ represents the monetary downgrade value for a particular seat that is indexed by the indexing variable i. The parameter ‘Purchased seat price’ represents a price at which the particular seat sold. The parameter ‘cheaper seat price’ represents asking/listing prices of another seat that was available at the time the particular seat was purchased at the purchased seat price. The parameter ‘number of instances’ represents a number of times the particular seat was purchased while the other seat was available.

The historical ticket value 210 may be based on the historical transaction information 216 and/or the event information 217. For example, the historical transaction information 216 may include one or more of the parameters ‘number of instances’, ‘cheaper seat price’, and ‘Purchased seat price’. The historical ticket value 210 may accordingly represent an average price to upgrade to the particular seat from less-expensive seats over numerous sales. The historical ticket value 210 may be calculated for each location or seat in a venue.

Additionally or alternatively, the historical ticket value 210 may be calculated to represent a downgrade value from a more-expensive available location. For instance, the historical ticket value 210 may be calculated for a particular seat by relating a ticket purchased for the particular seat to other tickets that were more-expensive and concurrently for sale. The historical ticket value 210 may accordingly provide information regarding a price for the particular seat versus a purchase of a better seat (e.g., an upgrade).

In these and other embodiments, the historical value module 204 may calculate the historical ticket value 210 for a seat according to an upgrade value expression:

$${MUV}_{i} = \sum \frac{Purchased seat price - more\_expensive seat price}{Number of instances} .$$

In the upgrade value expression, the parameters i, ‘Purchased seat price’, and ‘number of instances’ are as described above. The parameter MUVᵢ represents the monetary upgrade value for a particular seat that is indexed by the indexing variable i. The parameter ‘more-expensive seat price’ represents asking/listing prices of another seat that was available at the time the particular seat was purchased at the purchased seat price. Similar to the downgrade value expression described above, the historical ticket value 210 may be based on the historical transaction information 216 and/or the event information 217. For example, the historical transaction information 216 may include one or more of the parameters ‘number of instances’, ‘more-expensive seat price’, and ‘Purchased seat price’. The historical ticket value 210 may accordingly represent an average price to downgrade to the particular seat from more-expensive seats over numerous sales.

In some embodiments, in the upgrade value expression and/or the downgrade value expression, before price differences over numerous sales are averaged, the prices altered to reflect normalized values, which may partially compensate for differences in the value of the event itself. For instance, one or more of the ‘cheaper seat price’, the ‘more-expensive seat price’, and the ‘Purchased seat price’ may be divided by an average ticket price for an event.

Additionally or alternatively, the upgrade value expression and/or the downgrade value expression may be based on percentages or percentage differences. For example, the downgrade value expression may replace (Purchased seat price−cheaper Seat Price) in the above expression with a quotient of (Purchased seat price−cheaper seat price) to (cheaper seat price).

In some embodiments, multiple events at the venue may be used to calculate the historical ticket value 210. The historical ticket value module 204 may use similar events to calculate the historical ticket value 210. For example, if a concert and a basketball game were played at the venue, the ticket sales for the concert might not be used for establishing the historical ticket values for the basketball game. The system may match certain information about the events to tailor the valuations to the particular event. For example, the historical ticket value module 204 may look for matching teams, players, game time, time of year, time of day, and/or the like. Although the above example uses the average, other statistical estimation methods may be used, such as the median and/or mode.

In some embodiments, the quality module 202 and/or the historical ticket value module 204 may be responsive to the ticket listing 230. For example, in some embodiments, the historical ticket value module 204 and/or the quality module 202 may match information in the ticket listing 230 with information included in the historical transaction information 216. Based on the match, the historical ticket value module 204 may calculate the historical ticket value 210 that is relevant to the ticket listing 230 and/or the quality module 202 may generate the quality value 208 that is relevant to the ticket listing 230. In these and other embodiments, the historical ticket value module 204 and/or the quality module 202 may accordingly tailor the historical ticket value 210 and/or quality score 208 to an upcoming event for which the ticket listing 230 is received. Some examples of information that may be matched between the ticket listing 230 and the historical transaction information 216 may include an event type (e.g. concert, basketball, baseball, hockey, football, soccer, etc.), a time of year (month, quarter, etc.), an importance of the event (championships, finals, semi-finals, playoffs, preseason, regular season, all-star, etc.), an event participant, and the like.

The current ticket value module 206 may be configured to calculate the current ticket value 212. As mentioned above, the current ticket value 212 may provide a value (e.g., a quality per price) of a location in the venue relative to one or more other locations in the venue. The current ticket value 212 may be based on the ticket listing 230 communicated from the second user device 104B and the event information 217. In particular, the current ticket value 212 may be based on a ticket price included in the ticket listing 230 and prices of other seats that are currently available, which may be included in the event information 217.

In some embodiments, the current ticket value 212 may be calculated to represent a downgrade value from a more-expensive available location to the location represented in the ticket listing 230. For instance, the current ticket value 212 may be calculated for a particular seat by relating a ticket price in the ticket listing 230 to other tickets that are more-expensive. The other tickets may be concurrently for sale for the event or may be previously purchased, but for the event. The current ticket value 212 may accordingly provide information regarding a price for the particular seat in the ticket listing 230 versus a purchase of a better seat (e.g., an upgrade).

In some embodiments, the current ticket value 212 may be calculated to represent an upgrade value from a less-expensive available location to the location represented in the ticket listing 230. For instance, the current ticket value 212 may be calculated for a particular seat by relating a ticket price for the particular seat to other tickets that are less-expensive. Again, the other tickets may be concurrently for sale for the event or may be previously purchased, but for the event. The current ticket value 212 may accordingly provide information regarding a price for the particular seat versus a purchase of a worse seat (e.g., a downgrade).

The current ticket value 212 may include calculation of an average price difference between the price from the ticket listing 230 and prices of the other tickets. The average price difference may be calculated by subtracting one seat price from another seat price. Additionally or alternatively, in some embodiments, the average price difference may be represented as a percentage increase or decrease from one or more of the other seats. For example, a seat that is 50 dollars is 100% more expensive than a seat that is 25 dollars. Additionally or alternatively, in some embodiments, the price differences may be normalized compared to the historic ticket value 204 for the location.

The deal score module 205 may be configured to calculate a deal score 214 for one or more locations in the venue. The deal score 214 may be calculated for some or all of the tickets for sale for an upcoming event at the venue. In some examples the deal score 214 may represent how much overpriced or underpriced a ticket for the location is in relation to other available locations.

The deal score module 205 may calculate the deal score 214 based on the current ticket value 212, the historical ticket value 210, the quality score 208, the ticket listing 230, or some combination thereof. The deal score module 205 may compare a calculated historical ticket value 210 of a seat that is reserved by a ticket with a current ticket value 212.

For example, a first seat may be for sale for $50 and a second seat may be for sale for $25. The current ticket value 212 for the first seat in relation to the second seat may be represented by a percentage as 100%. However, based on the historical ticket values 210 the relationship between a price of the first seat and a price of the second seat has been 80% (e.g., the first seat price is $45 when the second seat price is $25). The deal score 214 may reflect that the price of $50 for the first seat is overpriced by 20%.

The deal score module 205 may calculate a deal score 214 for the first seat in relation to some or all other locations in the venue or in relation to some or all other locations that are available for the upcoming event. In some embodiments, the deal scores 214 for the first seat relative to the other locations may be averaged. The average deal score may be a final deal score or the deal score 214 for the location.

For example, there may be four seats available at an upcoming event. The first seat and the second seat are described above with a first deal score with a 20% (+20). The (+/−) indicators may indicate whether the score is an overpriced (+) or underpriced (−). The first seat may be overpriced by 15% (+15%) in relation to a third seat and underpriced by 10% (−10) to a fourth seat. The deal score module 205 may then average the underpriced or overpriced seat relationships (e.g., ((+20)+(+15)+(−10))/3=(+8.33)).

In some embodiments, the deal score 214 may be calculated by having every seat available for sale compared to every other seat available for sale at a venue to calculate an averaged deal score 214 for each seat (e.g. an average of how much a seat is under or overvalued compared to every other seat).

In some embodiments, the deal score module 205 may not compare the price in the ticket listing 230 to every location in the venue. Instead, in some embodiments, the price in the ticket listing 230 may be compared to other seats for sale within the same section, within the seating area, and/or comparable sections instead of every other location. In some embodiments, the price in the ticket listing 230 may be compared to other seats for sale with similar equal quality scores 208 and/or to other locations that include quality scores 208 within a particular quality score range.

The filter module 207 may be configured to determine whether the locations in the venue include characteristics that are within the preferences 228. For example, the filter module 207 may be configured to determine whether a first seat and/or a second seat include characteristics that are within the preferences 228 such as a seat quality preference and/or a price preference.

In response to a determination that the locations do not include characteristics that are outside the preferences 228, the filter module 207 may filter the ticket listing 230 for such location from the recommendation data 226. For example, in response to the ticket listing 230 including a quality score 208 that is outside of a seat quality preference, the filter module 207 may filter the ticket listing 230 from the recommendation data 226. Similarly, in response to the ticket listing 230 including a price that is outside of the price preference, the filter module 207 may filter the ticket listing 230 from the recommendation data 226.

In response to a determination that the locations include characteristics that are within the preferences 228, the filter module 207 may rank the deal scores 214. For example, a first location with a best deal score may be ranked above another location with a lower deal score, which may be ranked above yet another location with the lowest deal score.

The filter module 207 may adapt or configure the recommendation data 226 according to the rank of the deal scores 214. For instance, the filter module 207 may determine whether a first deal score of a first seat is greater than a second deal score of a second seat. In response to the first deal score being greater than the second deal score, the filter module 207 may configure the recommendation data 226 such that when the recommendation data 226 is displayed at the first user device 104A, a first ticket listing for the first seat is positioned relative to a second ticket listing for the second seat to indicate that the first deal score is greater than the second deal score. An example of the first ticket listing being positioned relative to the second ticket listing to indicate that the first deal score is greater than the second deal score may include the first ticket listing being positioned nearer to the top of display window than the ticket listings 230.

In some embodiments, the filter module 207 may also be configured to receive a selection of a seating section. The selection of the seating section may be based on additional user input used to select a seating section in the venue. For instance, the marketplace server 110 may be configured to display on the first user device 104A a map of the venue that include multiple icons that are representative of seating sections of the venue. The first user 102A may select one or more of the multiple icons using a computer mouse or a touchscreen input.

The filter module 207 may determine whether one or more seats are located within the selected seating section. In response to a determination that the seats are located outside the selected seating section, the filter module 207 may filter a ticket listing (e.g., 230) from the recommendation data 226 that corresponds to the seats located outside the selected seating section.

In some embodiments, the marketplace server 110 may be configured to communicate recommendations to users (e.g., the second user 102B) interfacing with the marketplace server 110 as buyer entities. For example, in FIG. 2, price suggestion data 232 may be generated by the marketplace server 110 and communicated to the second user device 104B. The price suggestion data 232 may include a suggested price for a location in the venue. The price included in the price suggestion data 232 may be determined to place a ticket listing for the location within a particular deal score range or at a particular deal score. The price suggestion data 232 may be based on the historical ticket value 210, the historical transaction information 216, the event information 217, or some combination thereof. Generation of the price suggestion data 232 may involve the same algorithm(s) used in calculation of the deal score 214, the current ticket value 212, etc. described above.

In embodiments in which the marketplace server 110 generates the price suggestion data 232, the second user device 104B may communicate a request (not shown) to the marketplace server 110. The request may include a particular location in the venue, a desired deal score, a desired deal score range, other event information, or some combination thereof. In response, the historical ticket value module 204, the current ticket value module 206, the deal score module 205, or some combination thereof may generate the price suggestion data 232 to include a price for the particular location such that a ticket for the location will receive quality score that is substantially equal to the desired deal score or within the desired deals score range.

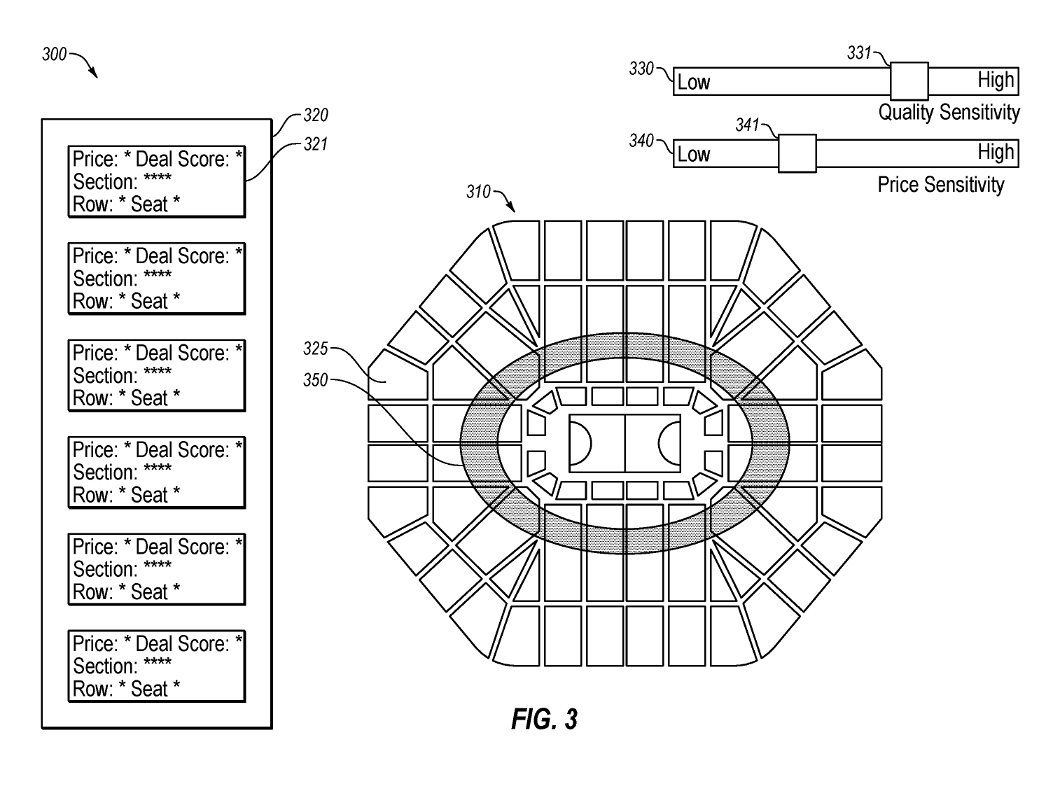

FIG. 3 is an example graphical user interface (GUI) 300. The GUI 300 may be implemented in the operating environment 100 of FIG. 1. The GUI 300 may be displayed to a ticket purchaser (e.g., one of the users 102 of FIGS. 1 and 2) for ticket purchases. In some embodiments, the GUI 300 may be displayed on a user device, such as one or more user devices 104 of FIGS. 1 and 2. The GUI 300 may be configured to receive input from one of the user and communicate the input or data representative thereof to a marketplace server (e.g., the marketplace server 110 of FIGS. 1 and 2).

The GUI 300 may display a seating map 310 for a venue. In some embodiments, a user may be able to zoom in on seating map 310 or some portion thereof to see individual seat locations. The seating map 310 may include separated seating sections, seating areas, and positions in the venue. One of the icons representative of one of the seating sections 325 is labelled in the GUI 300 of FIG. 3.

In some embodiments, the seating sections 325 or icons representative thereof may be selectable. For instance, upon selection, available tickets for sale in the selected seating sections may be displayed in the GUI 300.

In some embodiments, information about tickets for sale may be displayed in a window 320. In the window, the information about the tickets may be individually identified. For example, a first ticket is identified in a first ticket portion 321 in FIG. 3. In some embodiments, the tickets for sale may be displayed in a list format. The first ticket portion 321 may display information about the ticket, such as its deal score, section location, row number, seat number, and/or the like. The window 320 may display portions of the recommendation data described with reference to FIG. 2.

In some embodiments, the GUI 300 may provide one or more slider bars 330 and 340 with sliders 331 and 341. The slider bars 330 and 340 may be configured to enable input of data through manipulation of the sliders 331 and 341 relative to the slider bars 330 and 340. The data input via the slider bars 330 and 340 may indicate certain preferences of the user. For example, with combined reference to FIGS. 2 and 3, the first user 102A may communicate the preference 228 to the marketplace server 110 using the slider bars 330 and 340.

In the embodiment of FIG. 3, the slider bars 330 and 340 may be configured for input related to quality sensitivity and price sensitivity, which may be types of preferences. As discussed above, the preferences may be used for filtering recommendation data, which may alter the information in the window 320.

For instance, the user may set quality and price sensitivities as their preference. Information related to the set quality and price sensitivities may be sent to the marketplace server 110 of FIG. 2 (e.g., as preferences 228 of FIG. 2) for filtering tickets that match the user entered preferences. The marketplace server 110 may filter out tickets for sale that do not fall into the user set criteria as described elsewhere in this disclosure. In some embodiments, the tickets for sale that satisfy the user set quality and price sensitivity may be included in the recommendation data 226 and may be displayed in the window 320.

In some embodiments, an indicator 350 may be displayed over the seating map 310 or a portion thereof. The indicator 350 may delineate the area in which the seats associated with the tickets that satisfy the user set criteria are located. Although the indicator 350 is shown as a shaded ring, other shapes may be used, such as a rectangle or any other shape.

In some embodiments, the GUI 300 may display indicators (not shown) for one or more seats that satisfy the preferences. The indication may highlight where each seat is located in the seat map 310. Additionally, in some embodiments, one or more of the seating sections may include actuatable elements. The user may manually include and exclude from being filtered out for display to the user when actuated.

In some embodiments, the seating sections 325 may include information about the demographics (not shown) of people sitting in those areas. For example, some seating sections 325 may be family friendly while other sections may be geared towards young adults.

In these and other embodiments, the user may be able to select preferences to include and or exclude tickets for sections based on the demographics and/or the demographics that the section is targeted to. For instance instead of or in addition to the slider bars 330 and 340, there may be a slider that received input related to demographics.

The preferences, such as price sensitivity, quality sensitivity, demographic, and other preferences may be saved. In embodiments in which the preferences are saved, a marketplace server (e.g., the marketplace server 110) may default to the saved preferences. Additionally or alternatively, the preferences may be automatically defaulted based on user purchase histories and/or profile information. For instance, if the user repeatedly purchases kids tickets, the system may automatically pick sections that are kid friendly.

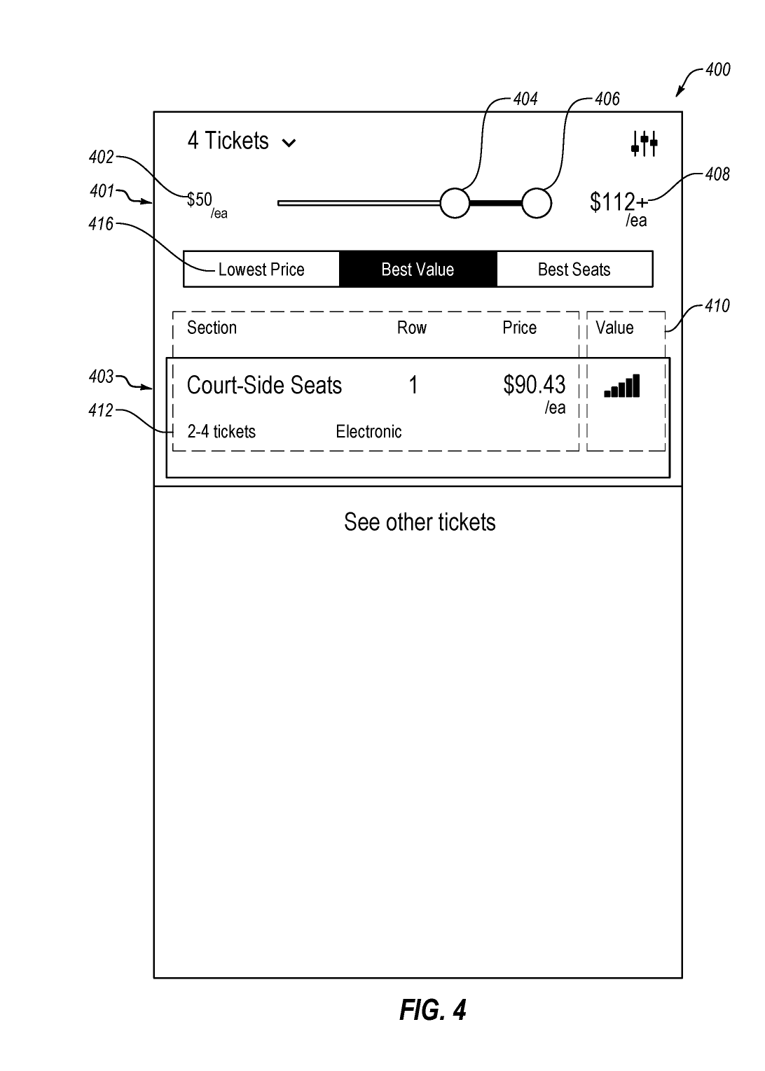

FIG. 4 is another example window 400 that includes one or more actuatable elements 416. The window 400 may be included in the GUI 300 of FIG. 3 or other GUIs implemented in the operating environment 100 of FIG. 1. The window 400 may be similar to the window 320 described with reference to FIG. 3.

The window 400 of FIG. 4 may include a price slider bar 401. The price slider bar 401 may enable a user to enter a price preference. The price slider bar 401 may include a lower end price 402, an upper end price 408, and two sliders 404 and 406. The price slider bar 401 may enable positioning of the two sliders 404 and 406 to create a price range.

The actuatable elements 416 may be selected, which may determine which ticket listing may be included in a ticket listing portion 403. For example, in FIG. 4, a ‘best value’ actuatable element 416 is selected. Accordingly, in the ticket listing portion 403, a ticket listing that includes a ticket listing for a best valued ticket is displayed. The best valued ticket may relate to the deal score as described in this disclosure. Included in the actuatable elements 416 are also the ‘lowest price’ actuatable element and the ‘best seat’ actuatable element. Selection of the ‘lowest price’ actuatable element may list available tickets sorted based on asking/listing price. Selection of the ‘best seat’ actuatable element may list available tickets sorted based on quality score as described in the disclosure. The ticket listing may include ticket information 412 such as section, row, and price. The ticket listing may also include an icon indicative of a value 410 of the ticket listing. The value 410 icon is related to the deal score as described in this disclosure.

FIG. 5 illustrates an example computing system 500 configured for ticket value assessment based on user preferences. The computing system 500 may be implemented in the operating system 100 of FIG. 1, for instance. Examples of the computing system 500 may include the user devices 104 and/or the marketplace server 110. The computing system 500 may include one or more processors 504, a memory 508, a communication unit 502, the user interface device 512, and a data storage 501 that includes the ticket module 108 and the server ticket module 114 (collectively, modules 108/114).

The processor 504 may include any suitable special-purpose or general-purpose computer, computing entity, or processing device including various computer hardware or software modules and may be configured to execute instructions stored on any applicable computer-readable storage media. For example, the processor 504 may include a microprocessor, a microcontroller, a digital signal processor (DSP), an ASIC, an FPGA, or any other digital or analog circuitry configured to interpret and/or to execute program instructions and/or to process data.

Although illustrated as a single processor in FIG. 5, the processor 504 may more generally include any number of processors configured to perform individually or collectively any number of operations described in the present disclosure. Additionally, one or more of the processors 504 may be present on one or more different electronic devices or computing systems. In some embodiments, the processor 504 may interpret and/or execute program instructions and/or process data stored in the memory 508, the data storage 501, or the memory 508 and the data storage 501. In some embodiments, the processor 504 may fetch program instructions from the data storage 501 and load the program instructions in the memory 508. After the program instructions are loaded into the memory 508, the processor 504 may execute the program instructions.

The memory 508 and the data storage 501 may include computer-readable storage media for carrying or having computer-executable instructions or data structures stored thereon. Such computer-readable storage media may include any available media that may be accessed by a general-purpose or special-purpose computer, such as the processor 504. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 504 to perform a certain operation or group of operations.

The communication unit 502 may include one or more pieces of hardware configured to receive and send communications. In some embodiments, the communication unit 502 may include one or more of an antenna, a wired port, and modulation/demodulation hardware, among other communication hardware devices. In particular, the communication unit 502 may be configured to receive a communication from outside the computing system 500 and to present the communication to the processor 504 or to send a communication from the processor 504 to another device or network (e.g., 122 of FIG. 1).

The user interface device 512 may include one or more pieces of hardware configured to receive input from and/or provide output to a user. In some embodiments, the user interface device 512 may include one or more of a speaker, a microphone, a display, a keyboard, a touch screen, or a holographic projection, among other hardware devices.

The modules 108/114 may include program instructions stored in the data storage 501. The processor 504 may be configured to load the modules 108/114 into the memory 508 and execute the modules 108/114. Alternatively, the processor 504 may execute the modules 108/114 line-by-line from the data storage 501 without loading them into the memory 508. When executing the modules 108/114, the processor 504 may be configured to perform ticket value determination based on user preferences (e.g., method 600) as described elsewhere in this disclosure.

Modifications, additions, or omissions may be made to the computing system 500 without departing from the scope of the present disclosure. For example, in some embodiments, the computing system 500 may not include the user interface device 512. In some embodiments, the different components of the computing system 500 may be physically separate and may be communicatively coupled via any suitable mechanism. For example, the data storage 501 may be part of a storage device that is separate from a server, which includes the processor 504, the memory 508, and the communication unit 502, that is communicatively coupled to the storage device.

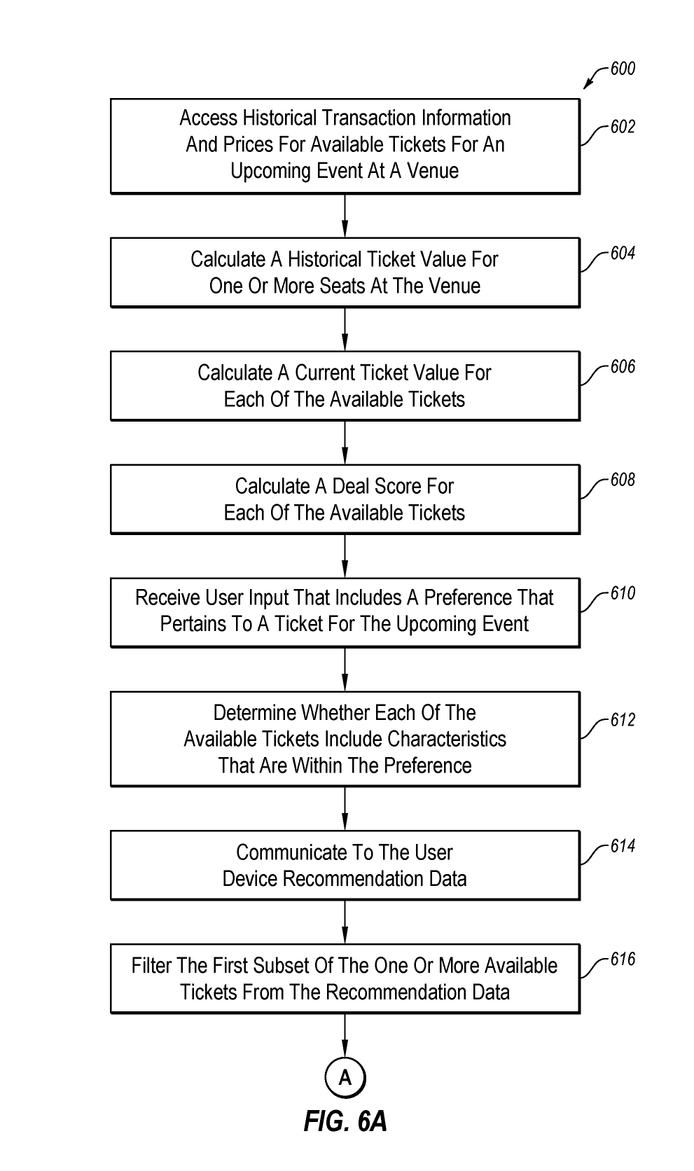

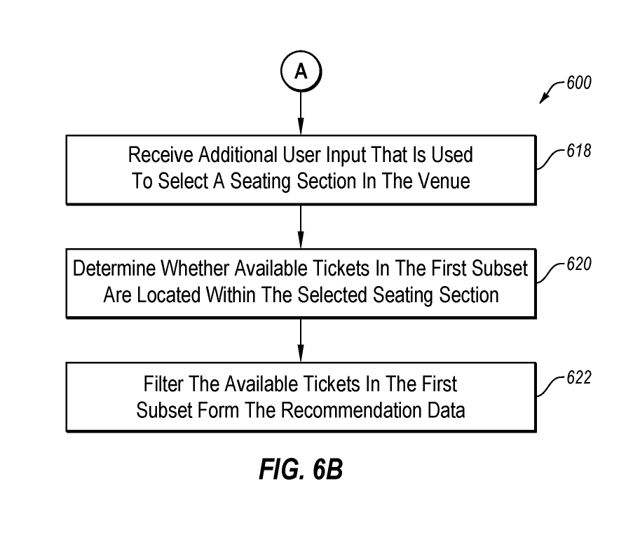

FIGS. 6A and 6B depict a flow chart of an example method 600 of ticket assessment in an online ticket marketplace. The method 600 may be performed in an operating system such as the operating system 100 of FIG. 1. The method 600 may be programmably performed in some embodiments by the marketplace server 110 described with reference to FIGS. 1 and 2. In some embodiments, the marketplace server 110 or another computing system may include or may be communicatively coupled to a non-transitory computer-readable medium (e.g., the memory 508 of FIG. 5) having stored thereon programming code or instructions that are executable by one or more processors (such as the processor 504 of FIG. 5) to cause a computing system and/or the marketplace server 110 to perform or control performance of the method 600. Additionally or alternatively, the marketplace server 110 may include the processor 504 described above that is configured to execute computer instructions to cause the marketplace server 110 or another computing system to perform or control performance of the method 600. Although illustrated as discrete blocks, various blocks in FIG. 6 may be divided into additional blocks, combined into fewer blocks, or eliminated, depending on the desired implementation.

With reference to FIG. 6A, the method 600 may begin at block 602 in which historical transaction information and prices for one or more available tickets for an upcoming event at the venue may be accessed. The historical transaction information may pertain to previous transactions for events at a venue from a transaction database. The historical transaction information may include a type of event, an event time, an event date, event participant, event importance, and a venue configuration. In some embodiments, a marketplace server such as the marketplace server 110 of FIG. 1 may access the historical transaction information.

At block 604, a historical ticket value may be calculated for one or more seats at the venue. The historical ticket value may be based on a price at which a particular seat sold relative to asking/listing prices for tickets for other seats that were available at the time the particular seat was purchased and a number of times the particular seat was purchased while the other seat was available. In some embodiments, the calculating the historical ticket value for the plurality of seats includes calculation of a monetary upgrade value of each of the plurality of seats according to an upgrade value expression described elsewhere in this disclosure. A marketplace server such as the marketplace server 110 of FIG. 1 may calculate the historical ticket value.

At block 606, a current ticket value may be calculated for each of the available tickets. The current ticket value may be based on an average price difference between the price of the available ticket and prices of other available tickets.

At block 608, a deal score may be calculated for each of the available tickets. The deal scores may be indicative of whether the available ticket is overpriced or underpriced. In some embodiments, the deal score may be based on a comparison between the current ticket value for the available ticket and the historical ticket value for the available ticket. In some embodiments, the deal score includes an averaged deal score that is calculated by averaging individual deal scores computed for the available ticket relative to each of the other available tickets.

At block 610, user input may be received that includes a preference that pertains to a ticket for the upcoming event. The user input may be received from a user device associated with a buyer entity.

At block 612, it may be determined whether the available tickets include characteristics that are within the preference. At block 614, recommendation data may be communicated to the user device. The recommendation data may be communicated in response to a determination that a first subset of the one or more available tickets includes characteristics that are within the preference. The recommendation data may include ticket listings for the one or more available tickets in the first subset. The recommendation data may be configurable in a window of a graphical user interface (GUI) such that the ticket listings are positioned relative to one another ranked according to the deal score of the available ticket.

At block 616, a second subset of the available tickets may be filtered from the recommendation data. The second subset of the available tickets may be filtered in response to a determination that the second subset of the available tickets does not include characteristics that are within the preference.

With reference to FIG. 6B, at block 618, additional user input may be received that is used to select a seating section in the venue. The additional user input may be received from the user device. At block 620, it may be determined whether available tickets in the first subset are located within the selected seating section. At block 622, one or more of the available tickets in the first subset from the recommendation data may be filtered. For example, one or more of the available tickets may be filtered in response to a determination that one or more of the available tickets in the first subset are outside the selected seating section.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments. For example, a quality score may be calculated. The quality score may be calculated for each of the seats. The quality scores may be indicative of an experience of a user positioned in the seat during events. In these and other embodiments, the preference may include a quality preference. In these and other embodiments, the determining of block 620, may include determining whether the quality score for each of the one or more available tickets meets the quality preference. In some embodiments, the quality score may be calculated based on one or both of an average purchase price of each of the plurality of seats and a distance of a point of interest at the venue to the associated seat location.

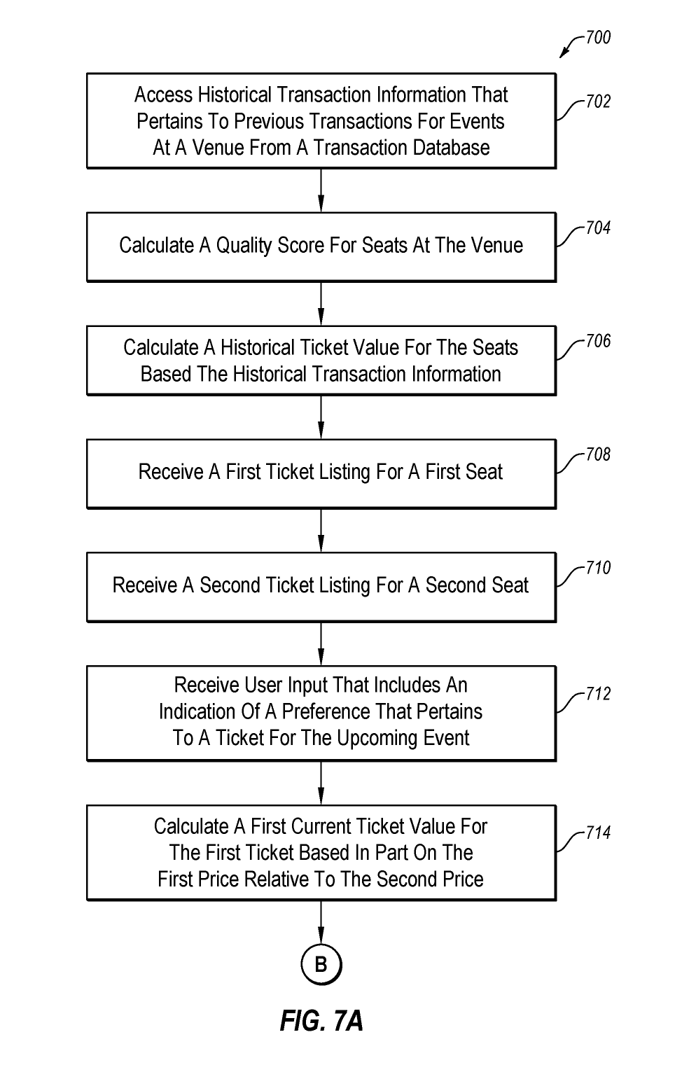

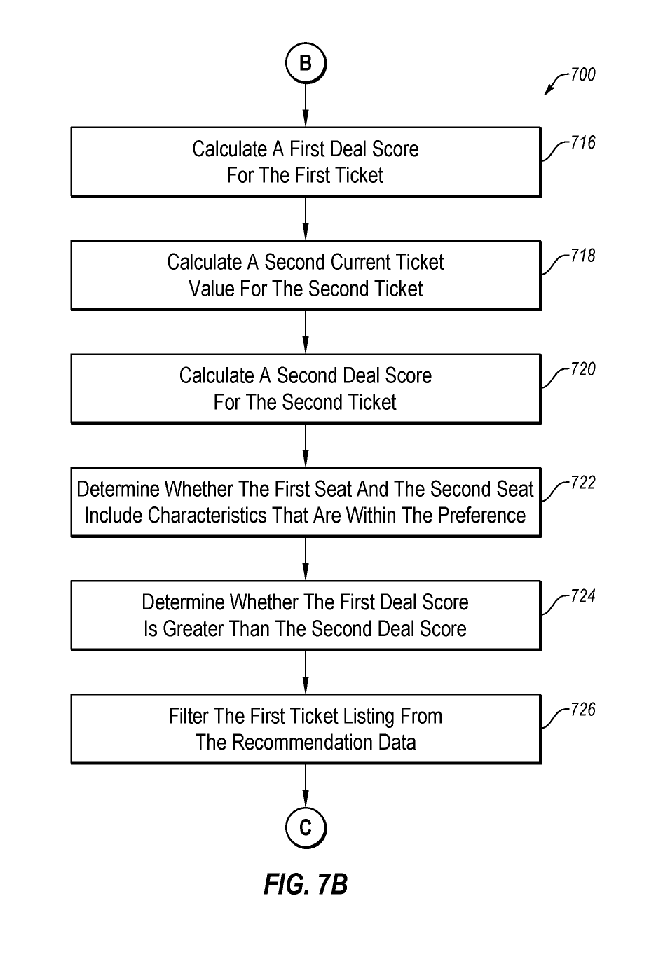

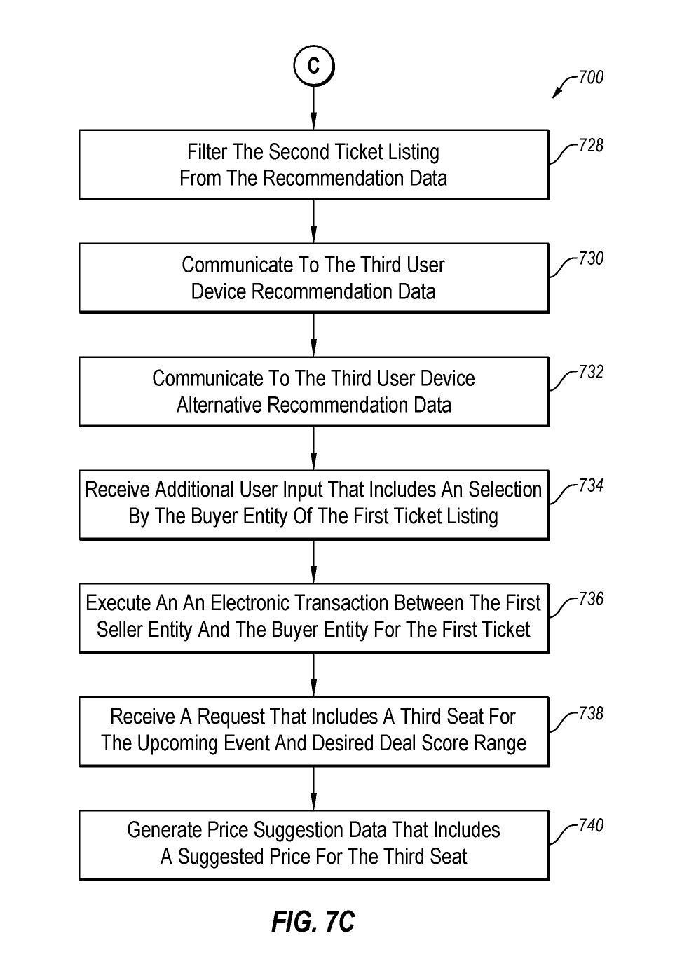

FIGS. 7A-7C depict a flow chart of another example method 700 of ticket assessment in an online ticket marketplace. The method 700 may be performed in an operating system such as the operating system 100 of FIG. 1. The method 700 may be programmably performed in some embodiments by the marketplace server 110 described with reference to FIGS. 1 and 2. In some embodiments, the marketplace server 110 or another computing system may include or may be communicatively coupled to a non-transitory computer-readable medium (e.g., the memory 508 of FIG. 5) having stored thereon programming code or instructions that are executable by one or more processors (such as the processor 504 of FIG. 5) to cause a computing system and/or the marketplace server 110 to perform or control performance of the method 700. Additionally or alternatively, the marketplace server 110 may include the processor 504 described above that is configured to execute computer instructions to cause the marketplace server 110 or another computing system to perform or control performance of the method 700. Although illustrated as discrete blocks, various blocks in FIG. 7 may be divided into additional blocks, combined into fewer blocks, or eliminated, depending on the desired implementation.

With reference to FIG. 7A, the method 700 may begin at block 702 in which historical transaction information may be accessed that pertains to previous transactions for events at a venue from a transaction database. At block 704, a quality score may be calculated for seats at the venue. The quality score may be calculated based at least in part on seat locations and the historical transaction information. The quality scores may be indicative of an experience of a user positioned in the seat during events. In some embodiments, calculation of the quality score for the seats is further based on at least one fixed metric, a distance from a point of interest of the venue to each of the plurality of seats, and comprises ranking the plurality of seats in order of most expensive to least expensive average price based on the historical transaction information for the venue.

At block 706, a historical ticket value may be calculated for the seats. The historical ticket value may be calculated based the historical transaction information. The historical ticket value may be indicative of historical prices paid for tickets for each of the seats relative to historical prices paid for tickets for each of the other seats. In some embodiments, calculation of the historical ticket value for the seats includes calculation of a monetary downgrade value of each of the plurality of seats according to a downgrade value expression described elsewhere in this disclosure.

At block 708, a first ticket listing may be received for a first seat of the seats. The first ticket listing may include a first price for a first ticket that reserves the first seat during an upcoming event. The first ticket listing may be received from a first user device associated with a first seller entity. At block 710, a second ticket listing may be received for a second seat of the seats. The second ticket listing may include a second price for a second ticket that reserves the second seat during the upcoming event. The second ticket listing may be received from a second user device associated with a second seller entity.

At block 712, user input may be received that includes an indication of a preference that pertains to a ticket for the upcoming event. The user input may be received from a third user device associated with a buyer entity. The preference may include one or more preference types selected from a group of preference types including a seat quality preference, a price preference, a demographics preference, a selected seating section, or some combination thereof. The user input received from the third user device may be received via positioning by the third user of a slider relative to a slider bar in a window of a GUI. At block 714, a first current ticket value may be calculated for the first ticket based in part on the first price relative to the second price. In some embodiments, the calculating the first current ticket value is further based on an average price difference between the first price and prices of other tickets for at least a subset of the plurality of seats.

With reference to FIG. 7B, at block 716, a first deal score may be calculated for the first ticket based on the first current ticket value relative to the historical ticket value for the first seat. The first deal score may be indicative of whether the first ticket is overpriced or underpriced. At block 718, a second current ticket value may be calculated for the second ticket based on the second price relative to the first price. At block 720, a second deal score may be calculated for the second ticket based on the second current ticket value relative to the historical ticket value for the second seat. The second deal score may be indicative of whether the second ticket is overpriced or underpriced.

At block 722, it may be determined whether the first seat and the second seat include characteristics that are within the preference. At block 724, it may be determined whether the first deal score is greater than the second deal score. In some embodiments, it may be determined in response to a determination that the first seat and the second seat include characteristics that are within the preference. At block 726, the first ticket listing may be filtered from the recommendation data. In some embodiments, the first ticket listing may be filtered from the recommendation data in response to a determination that the first seat is outside the preference.

With reference to FIG. 7C, at block 728, the second ticket listing may be filtered from the recommendation data. In some embodiments, the second ticket listing may be filtered from the recommendation data in response to a determination that the second seat is outside the seat quality preference and the price preference. At block 730, recommendation data may be communicated to the third user device. The recommendation data may be configurable in a display window such that the first ticket listing is positioned relative to the second ticket listing to indicate that the first deal score is greater than the second deal score. The recommendation data may be communicated in response to the first deal score being greater than the second deal score.

At block 732, alternative recommendation data may be communicated to the third user device. The alternative recommendation data may be configurable in the display window such that the second ticket listing is positioned relative to the first ticket listing to indicate that the second deal score is greater than the first deal score. The alternative recommendation data may be communicated in response to the second deal score being greater than the first deal score.

At block 734, additional user input may be received that includes a selection by the buyer entity of the first ticket listing. The additional user input may be received from the third user device. At block 736, an electronic transaction may be executed between the first seller entity and the buyer entity for the first ticket. The electronic transaction may be executed in response to reception of the additional user input. At block 738, a request may be received. The request may include a third seat of the seats for the upcoming event and desired deal score range. The request may be received from a fourth user device associated with a third seller entity. At block 740, price suggestion data may be generated. The price suggestion data may include a suggested price for the third seat. The suggest price may be determined to place the third ticket within the desired deal score range.

In some embodiments one or more switches, controllers, and/or other networking devices may include non-transient, tangible, machine readable media that include executable code that when run by one or more processors may cause the one or more processors to perform the processes of the methods described above. Some common forms of machine readable media that may include the processes described above are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method of ticket assessment in an online ticket marketplace, the method comprising:
accessing, by a marketplace server, historical transaction information that pertains to previous transactions for events at a venue from a transaction database and prices for one or more available tickets for an upcoming event at the venue;
calculating, by the marketplace server, a historical ticket value for a plurality of seats at the venue, the historical ticket value being based on a price at which a particular seat of the plurality of seats sold relative to asking/listing prices for tickets for other seats of the plurality of seats that were available at the time the particular seat was purchased and a number of times the particular seat was purchased while the other seat was available;
calculating, by the marketplace server, a current ticket value for each of the one or more available tickets based on an average price difference between the price of the available ticket and prices of other available tickets;
calculating, by the marketplace server, a deal score for each of the one or more available tickets, the deal scores being indicative of whether the available ticket is overpriced or underpriced;
receiving, from a user device associated with a buyer entity, user input that includes a preference that pertains to a ticket for the upcoming event;
determining, by the marketplace server, whether each of the one or more available tickets include characteristics that are within the preference;
in response to a determination that a first subset of the one or more available tickets includes characteristics that are within the preference, communicating to the user device recommendation data that includes ticket listings for each of the one or more available tickets in the first subset, the recommendation data being configurable in a window of a graphical user interface (GUI) such that the ticket listings are positioned relative to one another ranked according to the deal score of the available ticket; and
in response to a determination that a second subset of the one or more available tickets does not include characteristics that are within the preference, filtering, by the marketplace server, the second subset of the one or more available tickets from the recommendation data.

2. The method of claim 1, further comprising calculating, by the marketplace server, a quality score for each of the plurality of seats, the quality scores being indicative of an experience of a user positioned in the seat during events,
wherein:
the preference include a quality preference, and
the determining whether each of the one or more available tickets include characteristics that are within the preference includes determining whether the quality score for each of the one or more available tickets meets the quality preference.

3. The method of claim 2, wherein the quality score is calculated based on one or both of:
an average purchase price of each of the plurality of seats; and
a distance of a point of interest at the venue to the associated seat location.

4. The method of claim 1, wherein the historical transaction information includes a type of event, an event time, an event date, event participant, event importance, and a venue configuration.

5. The method of claim 1, wherein the deal score is based on a comparison between the current ticket value for the available ticket and the historical ticket value for the available ticket.

6. The method of claim 5, wherein the deal score includes an averaged deal score, the averaged deal score being calculated by averaging individual deal scores computed for the available ticket relative to each of the other available tickets.

7. The method of claim 1, wherein the calculating the historical ticket value for the plurality of seats includes calculation of a monetary upgrade value of each of the plurality of seats according to an upgrade value expression:
$${MUV}_{i} = \sum \frac{Purchased seat price - more\_expensive seat price}{Number of instances} ,$$
in which
i represents an indexing variable for the seats in the venue;
MUVᵢ represents the monetary upgrade value for a particular seat indexed by the indexing variable i;
Purchased seat price represents a price at which the particular seat sold;
more_expensive seat price represents asking/listing prices of another seat that was available at the time the particular seat was purchased at the purchased seat price; and
number of instances represents a number of times the particular seat was purchased while the other seat was available.

8. The method of claim 1, further comprising:
receiving, from the user device, additional user input used to select a seating section in the venue;
determining whether one or more available tickets in the first subset are located within the selected seating section; and
in response to a determination that one or more of the available tickets in the first subset are outside the selected seating section, filtering the one or more of the available tickets in the first subset from the recommendation data.

9. A system comprising:
one or more processors;
a communication unit communicative coupled to the one or more processors; and
one or more computer-readable storage media communicatively coupled to the one or more processors and storing instructions that, in response to execution by the one or more processors cause a component to perform operations of the method of claim 1.

10. A method of ticket assessment in an online ticket marketplace, the method comprising:
accessing, by a marketplace server, historical transaction information that pertains to previous transactions for events at a venue from a transaction database;
calculating, by the marketplace server, a quality score for a plurality of seats at the venue based at least in part on seat locations and the historical transaction information, the quality scores being indicative of an experience of a user positioned in the seat during events;
calculating, by the marketplace server, a historical ticket value for the plurality of seats based the historical transaction information, the historical ticket value being indicative of historical prices paid for tickets for each of the plurality of seats relative to historical prices paid for tickets for each of the other seats of the plurality of seats;
receiving, from a first user device associated with a first seller entity, a first ticket listing for a first seat of the plurality of seats, the first ticket listing including a first price for a first ticket that reserves the first seat during an upcoming event;
receiving, from a second user device associated with a second seller entity, a second ticket listing for a second seat of the plurality of seats, the second ticket listing including a second price for a second ticket that reserves the second seat during the upcoming event;
receiving, from a third user device associated with a buyer entity, user input that includes an indication of a preference that pertains to a ticket for the upcoming event;
calculating, by the marketplace server, a first current ticket value for the first ticket based in part on the first price relative to the second price;
calculating, by the marketplace server, a first deal score for the first ticket based on the first current ticket value relative to the historical ticket value for the first seat, the first deal score being indicative of whether the first ticket is overpriced or underpriced;
calculating, by the marketplace server, a second current ticket value for the second ticket based on the second price relative to the first price;
calculating, by the marketplace server, a second deal score for the second ticket based on the second current ticket value relative to the historical ticket value for the second seat, the second deal score being indicative of whether the second ticket is overpriced or underpriced;
determining, by the marketplace server, whether the first seat and the second seat include characteristics that are within the preference;
in response to a determination that the first seat and the second seat include characteristics that are within the preference, determining, by the marketplace server, whether the first deal score is greater than the second deal score; and
in response to the first deal score being greater than the second deal score, communicating to the third user device recommendation data that is configurable in a display window such that the first ticket listing is positioned relative to the second ticket listing to indicate that the first deal score is greater than the second deal score.

11. The method of claim 10, further comprising:
receiving, from the third user device, additional user input that includes an selection by the buyer entity of the first ticket listing; and
in response to reception of the additional user input, executing, by the marketplace server, an electronic transaction between the first seller entity and the buyer entity for the first ticket.

12. The method of claim 10, further comprising:
in response to a determination that the first seat is outside the preference, filtering the first ticket listing from the recommendation data; and
in response to a determination that the second seat is outside the seat quality preference and the price preference, filtering the second ticket listing from the recommendation data.

13. The method of claim 10, further comprising in response to the second deal score being greater than the first deal score, communicating to the third user device alternative recommendation data that is configurable in the display window such that the second ticket listing is positioned relative to the first ticket listing to indicate that the second deal score is greater than the first deal score.

14. The method of claim 10, wherein the calculating the first current ticket value is further based on an average price difference between the first price and prices of other tickets for at least a subset of the plurality of seats.

15. The method of claim 10, wherein the calculating the historical ticket value for the plurality of seats includes calculation of a monetary downgrade value of each of the plurality of seats according to a downgrade value expression:
$${MDV}_{i} = \sum \frac{Purchased seat price - cheaper seat price}{Number of instances} ,$$
in which
i represents an indexing variable for the seats in the venue;
MDVᵢ represents the monetary downgrade value for a particular seat indexed by the indexing variable i;
Purchased seat price represents a price at which the particular seat sold;
cheaper seat price represents asking/listing prices of another seat that was available at the time the particular seat was purchased at the purchased seat price; and
number of instances represents a number of times the particular seat was purchased while the other seat was available.

16. The method of claim 10, further comprising
receiving, from a fourth user device associated with a third seller entity, a request that includes a third seat of the plurality of seats for the upcoming event and desired deal score range; and
generating, by the marketplace server, price suggestion data that includes a suggested price for the third seat, the suggest price being determined to place the third ticket within the desired deal score range.

17. The method of claim 10, wherein the calculating the quality score for a plurality of seats is further based on at least one fixed metric, a distance from a point of interest of the venue to each of the plurality of seats, and comprises ranking the plurality of seats in order of most expensive to least expensive average price based on the historical transaction information for the venue.

18. The method of claim 10, wherein:
the preference includes one or more preference types selected from a group of preference types including a seat quality preference, a price preference, a demographics preference, and a selected seating section.

19. The method of claim 10, wherein the user input received from the third user device is received via positioning by the third user of a slider relative to a slider bar in a window of a graphic user interface (GUI).

20. One or more non-transitory computer-readable media storing one or more programs that are configured, in response to execution by one or more processors, to cause a system to execute or control the execution of the method as recited in claim 10.
